(19) United States
(12) Patent Application Publication
(10) Pub. No.: US 2007/0100640 A1
(43) Pub. Date: May 3, 2007

(54) Method for operating a detector for identifying the overlapping of flat mail in a sorting machine

(75) Inventor: André Rompe, Berlin Kaulsdorf (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 10/566,081

(22) PCT Filed: Jul. 27, 2004
(86) PCT No.: PCT/EP04/08376

§ 371 Date: Sep. 8, 2006

(30) Foreign Application Priority Data
Aug. 4, 2003 (DE) 103 35 645.2

(51) Int. Cl. G06Q 99/00

(52) U.S. Cl. 705/1

(57) ABSTRACT

The invention relates to a method whereby the average costs for each unidentified overlap in a distribution and sorting process and the average costs for the renewed sorting and distribution of each identified overlapped item of mail are determined. Before the sorting operation, the identification rate of the detector is determined at different working points according to an adjusting parameter. During the sorting operation, the respective actual overlap rate of the sorting machine is estimated, for defined time intervals, from the identification result, the identification rate and the error rate, according to the adjusting parameters. The actual adjusting parameter, with the greatest utility which is used to operate the detector until the next interval, is determined by optimization calculations from the relation for the utility of the sorting and distribution process for the operator.

The invention relates to a method for operating a detector for identifying the overlapping of flat mail items in a transport path of a sorting machine following on from a separation unit.

In conventional mail processing systems batches of mail items are separated in sorting machines. It can occur here that a number of mail items are withdrawn from the stack simultaneously, i.e. a number of overlapping items of mail leave the feeder and lead, if this problem is not detected, to mis-sorting. For these reasons it is necessary to detect the overlaps in good time after they have left the separation unit in order to guide them into a rejected items terminal/reject compartment (cf. U.S. Pat. No. 6,023,034 A).

Corresponding detectors have previously been known which determine overlaps caused by multiple withdrawals from the separation unit on the basis of a number of different measurement principles. The multiple withdrawals detected are guided into the rejected items terminals of the sorting machines to avoid incorrect distribution of the mail items. Thus DE 43 37 004 A1 describes a device and a method for detecting overlaps of bendable flat mail items in which in the transport path at least one section of each item can be moved at right angles to the direction of conveyance. At least one deflection element is arranged on the transport path, through which the movable mail item sections are deflected at right angles to the direction of conveyance by a predetermined amount during conveyance in the transport path. In one direction of detection, because of the springback behavior of the mail items the presence of overlapping mail item sections is detected.

Also known are corresponding detectors in which the narrow sides of the separated mail items are recorded by image recording devices and then evaluated in an image processing device by evaluating the image signals to establish whether a number of mail items are being transported overlapped, e.g. by counting the dark-to-light transitions (FR 2 546 083 A, 2 057 309 A).

All these detectors have a fixed point of operation with a specific error and detection rate in which they are operated independently of the process in which they are included.

The object of the invention is to create a method for automatic operation of a detector for detecting overlaps of flat mail items in a transport path following on from a separation unit of a sorting machine, in which the detector is operated as a function of the sorting and distribution process conditions.

In accordance with the invention the object is achieved by the features of claim 1.

In this case the average costs C_{NDD} of each undetected overlap in the distribution and sorting process and the average costs C_{RF} for the resorting and re-distribution of each detected overlapped mail item are determined off-line. Prior to sorting, the detection rate DR(Pᵢ) and the error rate ER(Pᵢ) of the detector is determined for different operating points, depending on a corresponding adjustment parameter Pᵢ. During sorting operation, for defined time intervals or intervals in which a defined number of mail items are processed in the sorting machine, the current overlap rate DFR′(Pᵢ) of the sorting machine in each case is estimated from the detection result, the detection rate DR(Pᵢ) and the error rate ER(Pᵢ) depending on the adjustment parameters Pᵢ.

From the equation for the benefit CB′(Pᵢ) of the operator of the sorting and distribution process
CB′(Pᵢ)=N{(DFR′(Pᵢ)*DR(Pᵢ)*(C_{NDD}−C_{RF}))−(ER(Pᵢ)*C_{RF}*(1−DFR′(Pᵢ)))}
the current adjustment parameter in optimizing calculations P_{opt. is subsequently determined} with the greatest utility CB′(P_{opt.}) with which the detector can be operated up to the next Interval. This means that the detector can automatically be operated to optimize costs even where costs and process conditions differ.

It is advantageous to determine the current overlap rate DFR′(Pᵢ) for the different setting parameters Pᵢ from the relationship

$${DFR}^{′} ( {P}_{i} ) = \frac{\frac{{N}_{AD}}{N} - {ER}^{′} ( {P}_{i} )}{{DR}^{′} ( {P}_{i} ) - {ER}^{′} ( {P}_{i} )} ,$$

with N_{AD} being the number of overlaps determined by the detector for the number N of detected mail items in an interval.

The invention will be explained in greater detail below with reference to the drawing in an exemplary embodiment.

The figures show

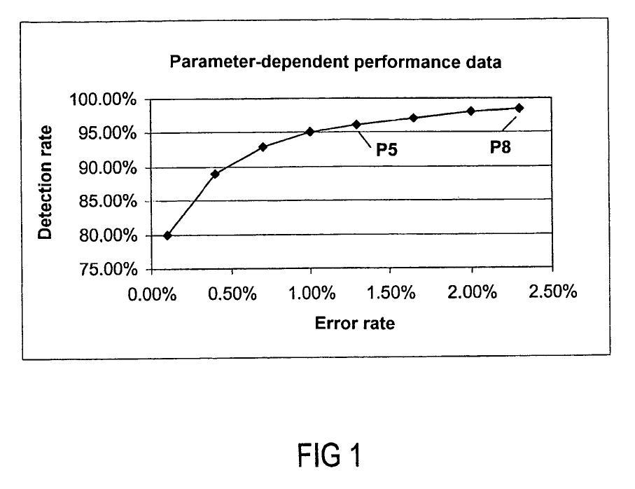

FIG. 1 a diagram of the detection rate and the error rate of a detector as a function of adjustment parameter Pᵢ;

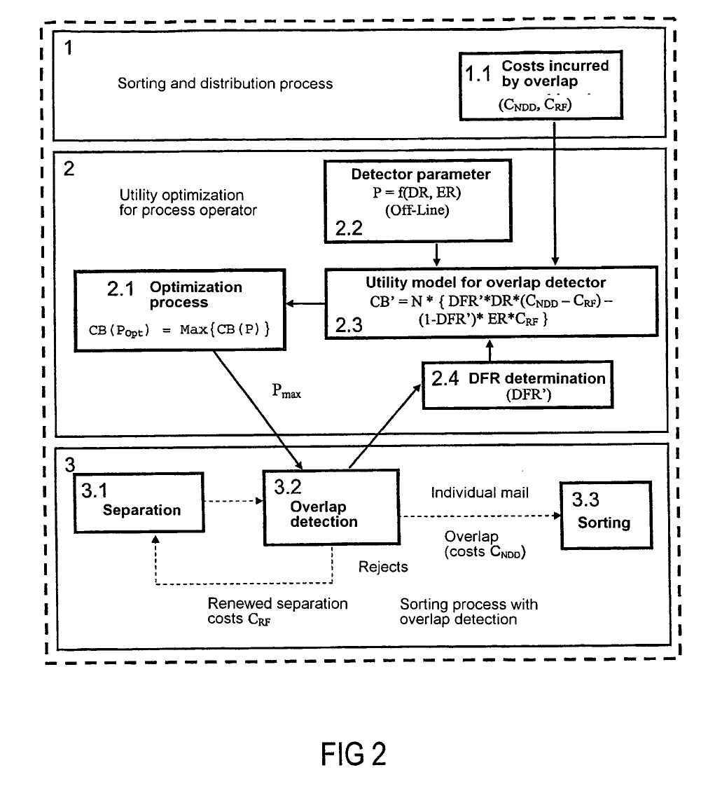

FIG. 2 a block diagram of the operating process.

The overlaps detected by the overlap detector, that its a number of mail items leaving the separation unit of the sorting machine overlapped, are directed into what is referred to as a reject compartment and then fed back again to the separation unit. The mail items filtered out in this way consist in this case of both true overlaps and mail items incorrectly detected as overlaps. If the overlapped mail items are not detected and filtered out the mail items associated with the item with the read address would at least be sent into the incorrect next distribution center and would then have to be forwarded to the correct address from there.

This naturally causes additional costs which, minus the costs of feeding the overlaps back through the unit, can be avoided by early detection of the overlaps. Since the detection process can also detect normal mail items incorrectly as overlaps as a result of incorrect detection, the costs for the additional sorting of these mail items in the relevant sorting machine must be subtracted from the additional costs saved.

The utility CB for the operator of the sorting and distribution process is thus produced by the following equation
CB=N{(DFR*DR*(C_{NDD}−C_{RF}))−(ER*C_{RF}*(1−DFR)}
Where
N*DFR*DR
is the number of overlaps detected in the observation period and
N*ER*(1−DFR)
is the number of incorrectly detected individual mail items, with

N=the number of mail items processed

DFR=the overlap rate of the sorting machine

DR=the detection rate of the detector

ER=the error rate of the detector

C_{NDD}=the costs of each overlap not detected

C_{RF}=the costs of each feed back to the relevant sorting machine of detected overlaps

These costs are dependent on the relevant type of mail item processing, i.e. whether for example input sorting or output sorting of the item is involved.

Detectors for determining overlapping previously operated with a fixed operation point with a specific detection rate DR and a specific error rate ER, which can be determined for example in accordance with DE file ref. 103 10 546.8-27.

In order to influence the utility for operation it is necessary to parameterize the detection and error rate, i.e. they are able to be changed as a function of an adjustment parameter Pᵢ. Examples of this dependency are shown in Tab. 1 and FIG. 1.

TABLE 1

| | P₁ | P₂ | P₃ | P₄ | P₅ | P₆ | P₇ | P₈ |
|---|---|---|---|---|---|---|---|---|
| ER | 0.1 | 0.4 | 0.7 | 1 | 1.3 | 1.7 | 2 | 2.3 |
| DR | 80.0 | 84.3 | 87.5 | 90.3 | 92.5 | 95.0 | 96.3 | 97.5 |

It can be seen from this table that as the detection rate increases the error rate also increases.

Thus the utility for the operator is produced by the following parameterized equation
CB′(Pᵢ)=N{(DFR′(Pᵢ)*DR(Pᵢ)*(C_{NDD}−C_{RF}))−(ER(Pᵢ)*CRF*(1−DFR′(Pᵢ)))}

The following estimated value for the current overlap rate of the relevant sorting machine is produced

$${DFR}^{′} ( {P}_{i} ) \frac{\frac{{N}_{AD}}{N} - {ER}^{′} ( {P}_{i} )}{{DR}^{′} ( {P}_{i} ) - {ER}^{′} ( {P}_{i} )}$$

The overall detection and optimization process is shown in FIG. 2.

The block diagram in FIG. 2 provides an overview of the execution sequence of the method. The overlap detector detects the overlaps during the sorting and distribution process 1, said overlaps then been fed into the reject compartment and thus being excluded from the regular process. This reduces the number of incorrect sortings and also the costs C_{NDD} of each overlap not correctly detected. The mail items from the reject compartments are fed back into the sorting machine and thus generate additional costs C_{RF} per mail item. These costs C_{NDD}, C_{RF} serve as input data for the utility optimization 2 for the process operator. They are derived off-line from the process model. It is evident in this case that these costs are dependent on the type of process involved, i.e. the incorrect sorting costs for what is known as input sorting and distribution process in accordance with a street and house number are different from the incorrect sorting costs and for what is known as the output sorting and distribution process in accordance with zip code and geographical location. In Table 2 for example the corresponding costs for a specific machine type (FVM) are specified.

TABLE 2

| | Machine | C_{NDD} | C_{RF} |
|---|---|---|---|
| Type of sorting | type | [US $] | [US $] |
| Input sorting | FVM | 0.058 | 0.0035 |
| Output sorting | FVM | 0.040 | 0.0035 |

The sorting process 3 with the overlapping detection includes the major components separation 3.1, followed by overlapping detection 3.2 and thereafter the sorting 3.3 in accordance with the destination addresses read. The detected overlaps are fed again via the reject compartments to the separation process 3.1. The mail items detected as individual mail items (including the undetected overlaps) are distributed into the sort compartments provided in accordance with the sorting plan.

From the number of overlaps detected with in the observation period and the parameterized performance figures ER′(Pᵢ) and DR′(Pᵢ) 2.2 the current estimated overlap rate DFR′ 2.4 is detected in the utility optimization 2.

From the utility equation/utility model 2.3
CB′(Pᵢ)=N{(DFR′(Pᵢ)*DR(Pᵢ)*(C_{NDD}−C_{RF}))−(ER(Pᵢ)*C_{RF}*(1−DFR′))}
the parameter Pₒₚₜ with the maximum utility CB′ is then determined in an optimization process 2.1

For the detector with the performance parameters shown in Tab. 1 and FIG. 1, error costs C_{NDD}=0,058, C_{RF}=0.0035 and N=1,000.000 processed mail items, Tab. 3 shows the utility depending on the overlap rate DFR′ and on the parameter Pᵢ. The maximum utility for each overlap rate is shown underscored and in bold type. The associated adjustment parameter Pᵢ is then the selected and automatic set parameter Pₒₚₜ.

TABLE 3

| DFR | P1 | P2 | P3 | P4 | P5 | P6 | P7 | P8 |
|---|---|---|---|---|---|---|---|---|
| 0.10% | [symbol] | [symbol] | [symbol] | [symbol] | [symbol] | [symbol] | [symbol] | [symbol] |
| 0.40% | [symbol] | [symbol] | [symbol] | [symbol] | [symbol] | [symbol] | [symbol] | [symbol] |
| 0.70% | [symbol] | [symbol] | [symbol] | [symbol] | [symbol] | [symbol] | [symbol] | [symbol] |
| 1.00% | [symbol] | [symbol] | [symbol] | [symbol] | [symbol] | [symbol] | [symbol] | [symbol] |
| 1.30% | [symbol] | [symbol] | [symbol] | [symbol] | [symbol] | [symbol] | [symbol] | [symbol] |
| 1.60% | [symbol] | [symbol] | [symbol] | [symbol] | [symbol] | [symbol] | [symbol] | [symbol] |
| 1.90% | [symbol] | [symbol] | [symbol] | [symbol] | [symbol] | [symbol] | [symbol] | [symbol] |
| 2.20% | [symbol] | [symbol] | [symbol] | [symbol] | [symbol] | [symbol] | [symbol] | [symbol] |
| 2.50% | [symbol] | [symbol] | [symbol] | [symbol] | [symbol] | [symbol] | [symbol] | [symbol] |

1. A method for operating a detector for detecting overlaps of flat mail items in a transport path following on from a separation unit of a sorting machine, the method comprising the steps of:
a) before sorting
a1) determining average costs for each undetected overlap in a distribution and sorting process and average costs for sorting and distribution each detected overlapped mail item again,
a2) determining a detection rate of the detector for the proportion of correctly detected overlaps and as an error rate for the mail items detected incorrectly as overlap as a function of an adjustment parameter, and
b) during sorting, automatically or after an interval respectively which is defined by a specified time or all by a specified number of mail items processed in the sorting machine,
b1) determining for a just ended interval, a detection result from a number of overlaps determined in this interval by the detector and a number of mail items determined in this interval by the detector,
b2) from the detection result Nm/N together with variables depending on a value of an adjustment parameter in this interval, undertaking an estimation of an overlap rate which has actually occurred in this interval,
b3) from the utility of an operator or of a sorting and distribution process, employing the following equation:
CB′(Pᵢ)=N{(DFR′(Pᵢ)*DR(Pᵢ)*(C_{NDD}−C_{RF}))−(ER(Pᵢ)*C_{RF}*(1−DFR′(Pᵢ)))}
in optimization calculations, those adjustment parameters determined which would have produced a greatest utility for this interval, wherein CB′(Pᵢ) is utility DFR′ (Pᵢ) is estimation of overlap rate, DR(Pᵢ) is detection rate C_{NDD} is average costs for undetected overlap, C_{RF} is average costs for sorting and distribution, and ER′(Pᵢ) is error rate, and
b4) determining for a next interval a value for an adjustment parameter and operating the detector for a next interval with this adjustment parameter.

2. The method according to claim 1, wherein the estimation of the overlap rate which actually occurred in the interval just ended is undertaken in accordance with the following equation:
$${DFR}^{′} ( {P}_{i} ) \frac{\frac{{N}_{AD}}{N} - {ER}^{′} ( {P}_{i} )}{{DR}^{′} ( {P}_{i} ) - {ER}^{′} ( {P}_{i} )}$$
wherein DFR′(Pᵢ) is estimation of overlap rate, DR′(Pᵢ) is detection rate, ER′(Pᵢ) is error rate, and N_{AD} is the number of determined overlaps.
